(19) United States
(12) Patent Application Publication
(10) Pub. No.: US 2026/0303323 A1
(43) Pub. Date: Oct. 1, 2026

(54) SPLIT-KEY ACCESS FOR INTEGRATED CIRCUITS WITH HARDWARE ROOTS OF TRUST

(71) Applicant: Xilinx, Inc., San Jose, CA (US)

(72) Inventors: Himanshu J. Verma, San Francisco, CA (US); Zhi Xin Koh, Singapore (SG); Matthew H. Klein, Redwood City, CA (US)

(73) Assignee: Xilinx, Inc., San Jose, CA (US)

(21) Appl. No.: 19/094,207

(22) Filed: Mar. 28, 2025

(51) Int. Cl. H04L 9/08; H04L 9/32

(52) U.S. Cl. CPC H04L 9/0825; H04L 9/085; H04L 9/3236

(57) ABSTRACT

Split-key access of an integrated circuit with a hardware Root of Trust includes generating, by computer hardware of a first entity, a hash of a public key of a key pair. The hash is split into a plurality of key shares. A first key share of the plurality of key shares is shared with a second entity, wherein the first key share is programmed into a reserved eFuse slot of an integrated circuit device by the second entity. A boot image signed by the second entity is loaded into the integrated circuit device. The boot image is configured to unlock access to circuitry configured to write to the reserved eFuse. A second key share of the plurality of key shares is programmed into the reserved eFuse slot.

### TECHNICAL FIELD

This disclosure relates to integrated circuit (IC) devices and, more particularly, to providing access to IC devices that include a hardware Root of Trust.

### BACKGROUND

A hardware Root of Trust (HWRoT) refers to a hardware component implemented within an integrated circuit (IC) device that is always trusted by the IC device. The HWRoT serves as a basis for verifying a boot image loaded into the IC device to implement secure boot functionality. The HWRoT is capable of performing particular security-related functions directly on or within the hardware of the IC device. These functions, which facilitate secure boot of the IC device, may include storing cryptographic keys, validating boot images, and/or establishing trust with other components within and/or coupled to the IC device.

An asymmetric-HWRoT (A-HWRoT) refers to an HWRoT that uses asymmetric public-private key (PPK) technology. In an IC device that includes an A-HWRoT in which secure boot functionality is enabled, the IC device may include a plurality of electronic fuse (eFuse) slots on silicon that may be programmed to store values such as hashes of public keys of a PPK pair. The IC device may only be booted by loading a boot image into the IC device that is signed with a private key corresponding to, or matching, a public key or hash thereof stored in one of the eFuse slots. This mechanism prevents bad actors from taking control of the IC device by loading an unauthorized boot image into the IC device.

In cases where secure boot functionality is used, one of the eFuse slots is often left unprogrammed. If there is a need to obtain support from the IC provider or have the IC provider run diagnostics on the IC device, the IC provider will need to program the unprogrammed eFuse slot to load a diagnostic boot image into the IC device for testing and/or analysis. The availability of an unprogrammed eFuse slot in the IC device, though necessary for testing purposes as described, is often considered a vulnerability by security conscious entities. A bad actor, e.g., an insider of the IC provider, for example, may secure boot the IC device using a legitimate key. The bad actor may then program the unprogrammed eFuse slot with an illegitimate key. This allows the bad actor to load a nefarious boot image into the IC device that may be validated against the illegitimate key thereby gaining access and control of the IC device when deployed in the field.

### SUMMARY

In one or more examples, a method includes generating, by computer hardware of a first entity, a hash of a public key of a key pair. The method includes splitting, by the computer hardware of the first entity, the hash into a plurality of key shares. The method includes sharing a first key share of the plurality of key shares with a second entity. The first key share is programmed into a reserved electronic fuse (eFuse) slot of an integrated circuit device by the second entity. The method includes loading into the integrated circuit device a boot image signed by the second entity. The boot image is configured to unlock access to circuitry configured to write to the reserved eFuse. The method includes programming a second key share of the plurality of key shares into the reserved eFuse slot.

In one or more examples, an integrated circuit device includes an Asymmetric-Hardware Root of Trust. The integrated circuit device includes a plurality of eFuse slots. A selected eFuse slot of the plurality of eFuse slots is reserved for diagnostics. The selected eFuse slot is writable at a first time to store a first portion of a hash of a public key of a key pair and writable at a second time subsequent to the first time to store a second portion of the hash.

In one or more examples, a system includes a hardware processor and one or more computer-readable storage mediums having program instructions stored thereon to cause the hardware processor to perform operations. The operations include generating, by computer hardware of a first entity, a hash of a public key of a key pair. The operations include splitting, by the computer hardware of the first entity, the hash into a plurality of key shares. The operations include sharing a first key share of the plurality of key shares with a second entity. The first key share is programmed into a reserved eFuse slot of an integrated circuit device by the second entity. The operations include loading into the integrated circuit device a boot image signed by the second entity. The boot image is configured to unlock access to circuitry configured to write to the reserved eFuse. The operations include programming a second key share of the plurality of key shares into the reserved eFuse slot.

This Summary section is provided merely to introduce certain concepts and not to identify any key or essential features of the claimed subject matter. Many other features and implementations of the disclosed technology will be apparent from the accompanying drawings and from the following detailed description.

### BRIEF DESCRIPTION OF THE DRAWINGS

The accompanying drawings show one or more implementations of the disclosed technology. The drawings, however, should not be construed to be limiting of the implementations to only the examples shown. Various aspects and advantages will become apparent upon review of the following detailed description and upon reference to the drawings.

FIG. 1 illustrates an example of an integrated circuit device including a plurality of electronic fuses (eFuses) and an asymmetric-hardware Root of Trust.

FIG. 2 illustrates an example method of split-key access to an IC device.

FIG. 3 illustrates an example of key-splitting as described in connection with FIG. 2.

FIGS. 4A, 4B, and 4C illustrate different examples of the state of a reserved eFuse slot subsequent partial programming.

FIGS. 5A, 5B, and 5C illustrate different examples of the state of a reserved eFuse slot as fully programmed.

FIG. 6 illustrates an example of a data processing system for use with the example implementations described herein.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to integrated circuit (IC) devices and, more particularly, to providing access to IC devices that include a hardware Root of Trust (HWRoT). Methods, systems, and computer program products are provided that facilitate access to an IC device having an HWRoT with secure boot functionality enabled without leaving the IC device vulnerable to attack by way of an unused eFuse slot. The implementations described within this disclosure provide a split-key technique in which one entity may permit another entity to access an IC device with secure boot enabled without leaving an electronic (eFuse) slot unused.

In one or more examples, an IC device that includes a plurality of eFuse slots may reserve one of the eFuse slots. An entity may write a portion of the reserved eFuse slot with a portion of a public key, which may be a hash of the public key, of a public-private key pair. At a later time, a different entity may write one or more other or all remaining portions of the reserved eFuse slot with the remaining portion(s) of the public key. By partially programming the reserved eFuse slot with a portion of a public key, assuming each other eFuse slot has been programmed or rendered unusable (e.g., revoked), no empty eFuse slots are available on the IC device that may be exploited by a bad actor. A bad actor is unable to program an illegitimate key into the IC device. This prevents the bad actor from hijacking the IC device by loading a nefarious boot image into the IC device that would be validated against any such illegitimate key.

In one or more implementations, a public key, or hash of the public key, may be split into a plurality of portions that may be shared among a plurality of entities. This allows one entity (e.g., a customer) to write their portion of the public key into a portion of a reserved eFuse slot. The IC device may be sent to another entity for any of a variety of different reasons. As an example, the IC device may be sent from a customer to an IC provider for diagnostic purposes. In that case, the IC provider, which is in possession of their portion of the public key, is able to program their portion of the public key in the remaining portion of the reserved eFuse slot of the IC device. Once the entire public key is programmed in the reserved eFuse slot, the IC provider may load diagnostic firmware into the IC. The diagnostic firmware is signed by the private key held by the IC provider which corresponds to the public key now programmed into the reserved eFuse slot.

The example implementations described within this disclosure provide increased security in cases where an IC device is provided to another entity. The increased security is achieved, at least in part, by leaving no eFuse slot open or unprogrammed. No entity is able to use the device without knowing the private key corresponding to the programmed eFuse slots programmed by the customer. No entity is able to take advantage of or exploit the partially programmed eFuse slot of the IC device as one requires knowledge of the public key or the hash thereof to complete programming of the reserved eFuse slot.

Further aspects of the disclosed technology are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

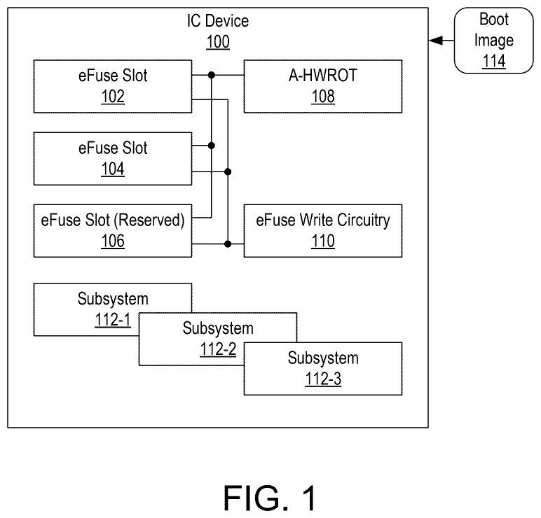

FIG. 1 illustrates an example of an IC device 100. In the example, IC device 100 includes a plurality of eFuse slots 102, 104, and 106, an asymmetric-HWRoT (A-HWRoT) 108, and eFuse write circuitry 110. IC device 100 also may include one or more subsystems 112 shown as subsystems 112-1, 112-2, and 112-3. Examples of different subsystems that may be included in IC device 100 individually or in any combination may include, but are not limited to, programmable circuitry (e.g., programmable logic), a processor system including one or more cores and/or processors capable of executing program code, one or more Application-Specific IC (ASIC) blocks (e.g., transceivers, input/output blocks, error correction circuits, etc.) digital signal processors (DSPs), graphics processing units (GPUs), neural processing units (NPUs), and/or the like. Another example of a subsystem 112 that may be included in IC device 100 is a Network-on-Chip (NoC) that may couple one or more or any combination of the other subsystem(s) 112 that are included in IC device 100.

In the example, each eFuse slot 102, 104, and 106 is a multi-bit storage element where each bit location is write-once. Once a bit in an eFuse slot is written (e.g., the bit location of the eFuse is blown), the bit may not be re-written and becomes read-only. Each eFuse slots 102, 104, and 106 may be programmed with a value such as a key to implement a secure boot process. Secure boot is a function that may be enabled in IC device 100 in which any boot image loaded into IC device 100 must be validated, by A-HWRoT 108, against a key, or hash of a key, stored in one of eFuse slots 102, 104, and/or 106.

Within this disclosure, it should be appreciated that reference to a public key may refer to the public key itself or a hash of that public key. As generally understood, a hash provides a unique fixed length identifier for a public key and does not require transmission or sharing of the public key itself. The term “boot image” refers to software, e.g., such as firmware, and/or data, e.g., configuration data, that may be loaded into and used to configure and/or program an IC device. The boot image may be loaded into the IC device to boot that IC device.

Any boot image, e.g., boot image 114, loaded into IC device 100 may not be implemented (e.g., may not be executed by or used to configure or program circuitry in IC device 100) unless A-HWRoT 108 successfully validates the boot image, which is signed using a private key, against a key stored in one of eFuse slots 102, 104, or 106. This means that any party that is not privy to the private key corresponding to a public key programmed into an eFuse slot is unable to load a boot image into IC device 100.

For example, if boot image 114 is digitally signed with a private key that corresponds to, or is matched to, a key stored in one of the eFuse slots, A-HWRoT 108 will allow IC device 100 to be programmed or configured by boot image 114. Programming or configuration of IC device 100 may include programing, configuring, and/or enabling, one or more or all of eFuse write circuitry 110 and/or any of subsystems 112. If boot image 114 is not digitally signed with a private key that corresponds to or matches a key stored in one of the eFuse slots, A-HWRoT 108 rejects the boot image. In that case, A-HWRoT 108 discards boot image 114 and does not program, configure, or enable any portion of IC device 100 using boot image 114.

In conventional scenarios where secure boot is enabled in IC device 100, one of eFuse slots 102, 104, or 106 is left unprogrammed so that if the part (IC device) is returned to the IC provider for diagnostics, the IC provider may program the unused eFuse slot with a key that may be used to validate diagnostic boot images loaded into IC device 100 for testing. The particular eFuse slot that is selected as the reserved eFuse slot may be one that is pre-agreed upon between the parties or entities (e.g., the customer and IC provider).

In the implementations described within this disclosure, eFuse slot 106 may be selected between the parties as the reserved eFuse slot for use in cases where the IC device is to be provided from one entity to another with secure boot having been enabled. As an example, a customer entity may obtain a Return Merchandise Authorization (RMA) for the return of IC device 100 to the IC provider for testing. In that case, where an entity such as the customer provides IC device 100 to another entity such as the IC provider for diagnostics, reserved eFuse slot 106 may be used. Reserved eFuse slot 106 is a selected one of the plurality of eFuse slots that is pre-agreed to remain available for such situations.

To avoid situations in which reserved eFuse slot 106 remains empty, thereby leaving IC device vulnerable to attack, whether in the field or as provided from one entity to another, reserved eFuse slot 106 may be partially programmed by the sending entity. Upon receipt of IC device 100 by the receiving entity, the remainder of reserved eFuse slot 106 may be further programmed as described herein in greater detail below. As such, reserved eFuse slot 106 is writable at a first time to store a first portion of a hash of a public key of a key pair and writable at a second time subsequent to the first time to store a second portion of the hash. Because reserved eFuse slot 106 is at least partially programmed, IC device 100 is not vulnerable to attack presuming that the other eFuse slots are programmed or rendered unavailable. Moreover, unless the remaining portion of reserved eFuse slot 106 is programmed with the remaining portion of the partially written key, the receiving entity or any other entity for that matter, will be unable to load a boot image into IC device 100 to hijack the device.

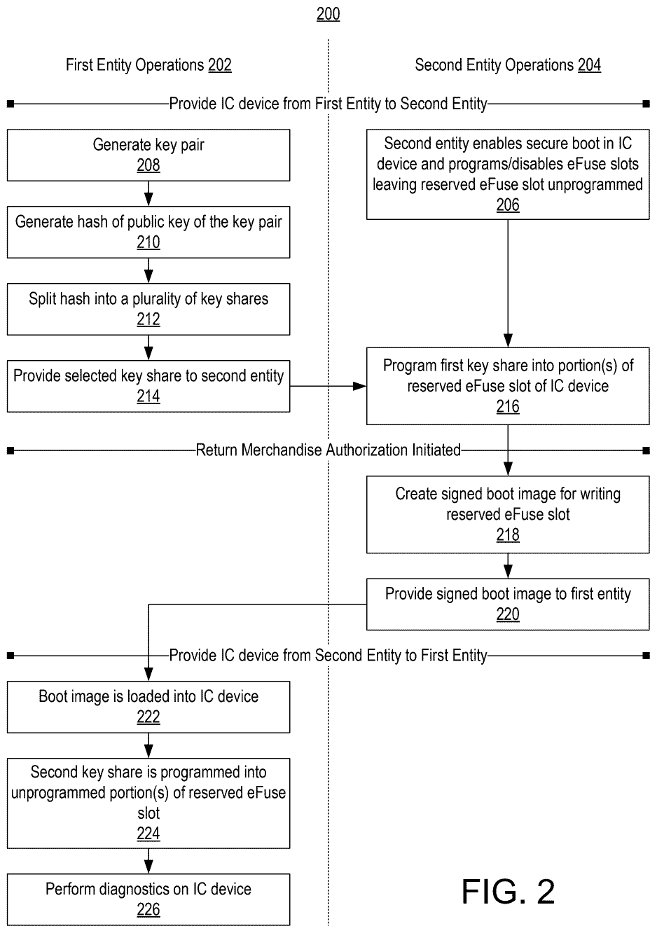

FIG. 2 illustrates an example method 200 of split-key access to an IC device having an HWRoT. Method 200 may be performed in connection with an IC device such as IC device 100 of FIG. 1. In the example of FIG. 2, the various operations illustrated may be performed by computer systems of a first entity and a second entity. As an example, the first entity may be the IC provider. The second entity may be a customer. Accordingly, those operations attributable to the first entity computer system are located on the left and are denoted as first entity operations 202. Those operations attributable to the second entity computer system are located on the right and are denoted as second entity operations 204.

Method 200 may begin in a state where the first entity provides (e.g., sells) an IC device, e.g., IC device 100, to the second entity. As noted, IC device 100 includes reserved eFuse slot 106. In block 206, the second entity computer system enables the secure boot function in IC device 100. As such, the second entity computer system is capable of programming one or both of eFuse slot 102 and eFuse slot 104 with a key or keys (e.g., or hashes thereof as noted). In some cases, the second entity computer system may program one of eFuse slot 102 or eFuse slot 104 and disable (e.g., revoke) the other. In any case, each eFuse slot other than reserved eFuse slot 106 is programmed with a key of the second entity or is revoked. Only reserved eFuse slot 106 remains unprogrammed at least initially or is not programmed using a key belonging to the second entity.

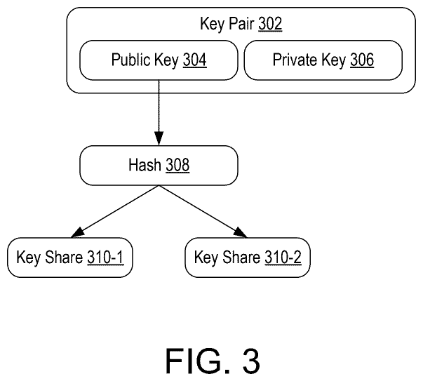

FIG. 3 illustrates certain aspects corresponding to the operations described in connection with FIG. 2. Referring to FIGS. 2 and 3, in block 208, the first entity computer system is capable of generating a key pair 302. Key pair 302 may be a public-private key pair. As illustrated in FIG. 3, key pair 302 includes a public key 304 and a private key 306. The public and private keys of a key pair may be said to “correspond” to one another.

In general, key pair 302 may be generated for use with an IC device in the case where the IC device is to be provided to the IC provider so that the IC provider may conduct diagnostics or other testing on the IC device. Still, in one or more examples, blocks 208-216 may be performed as a matter of course or regular interaction to proactively plan for the need for diagnostic services though such need may yet to have arisen.

In block 210, the first entity computer system generates a hash 308 of public key 304 of key pair 302. Hash 308 may be generated using any of a variety of known or to be developed hashing techniques. In block 212, the first entity computer system is capable of splitting hash 308 into a plurality of portions or segments referred to herein as key shares and shown as key share 310-1 and key share 310-2. In the example, through hash 308 is split into two key shares, in other examples, hash 308 may be split into more than two key shares. In block 214, a computer system of the first entity provides (e.g., sends or otherwise makes available) a selected key share such as key share 310-1 to the second entity computer system.

In block 216, the second entity computer system is capable of programming the selected key share, e.g., key share 310-1, into reserved eFuse slot 106 of IC device 100. As an illustrative example, the second entity may program the selected key share into reserved eFuse slot 106 as part of and/or during a board test phase. In this regard, reserved eFuse slot 106 may be partially programmed prior to deploying IC device 100 into the field.

Once the selected key share is programmed into reserved eFuse slot 106, no entity can secure boot IC device 100 using reserved eFuse slot 106. While the first entity does have private key 306, the first entity cannot hijack IC device 100. Only upon writing the remainder of hash 308, i.e., key share 310-2, into reserved eFuse slot 106 may the second entity load a boot image signed with private key 306. To write key share 310-2 to reserved eFuse slot 106, however, the second entity must be in possession of a boot image signed using a private key corresponding to a value/key stored in eFuse slot 102 or eFuse slot 104 that will allow the second entity to write key share 310-2 to the unprogrammed portion of reserved eFuse slot 106.

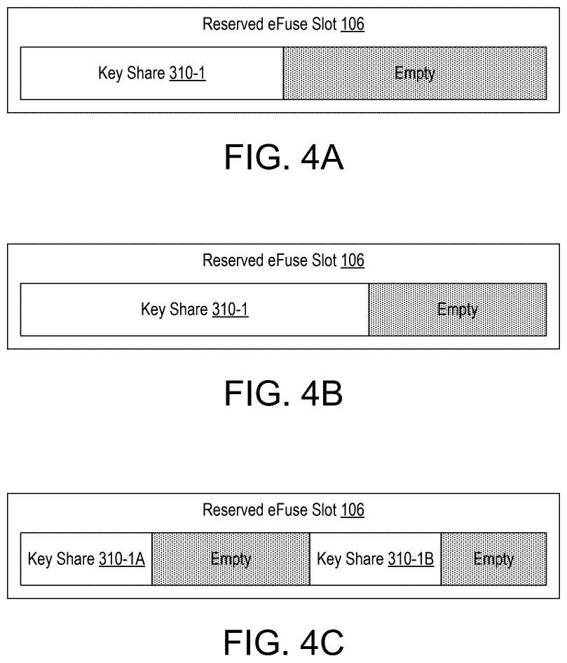

For purposes of illustration, FIGS. 4A, 4B, and 4C illustrate different examples of the state of reserved eFuse slot 106 subsequent to the second entity programming the selected key share into reserved eFuse slot 106. More particularly, FIGS. 4A, 4B, and 4C illustrate different examples of the state of reserved eFuse slot 106 subsequent to implementation of block 216 of FIG. 2.

In the example of FIG. 4A, hash 308 is split into two equal portions such that key share 310-1 and key share 310-2 include an equivalent number of bits. For purposes of illustration, if hash 308 is 256 bits, key share 310-1 may include bits 1-128 while key share 310-2 includes bits 129-256. In this example, key share 310-1 may include a first set of contiguous bits while key share 310-2 includes a second set of contiguous bits. In the example of FIG. 4A, key share 310-1 is programmed into a portion (e.g., a contiguous portion) of reserved eFuse slot 106 leaving another portion, shown as the shaded region, unprogrammed or empty.

In the example of FIG. 4B, hash 308 is split into two unequal portions such that key share 310-1 has fewer bits than key share 310-2. For purposes of illustration, if hash 308 is 256 bits, key share 310-1 includes bits 1-48, key share 310-2 includes bits 49-256. In this example, like that of FIG. 4A, key share 310-1 includes a first set of contiguous bits while key share 310-2 includes a second set of contiguous bits. In the example of FIG. 4B, key share 310-1 is programmed into a portion (e.g., a contiguous portion) of reserved eFuse slot 106 leaving another portion, shown as the shaded region, unprogrammed or empty.

In the example of FIG. 4C, hash 308 may be split into two portions where each portion includes non-contiguous bits. Each portion may have an equal number of total bits or an unequal number of total bits. For purposes of illustration, if hash 308 is 256 bits, key share 310-1 includes two non-contiguous sub-portions labeled A and B. Sub-portion A of key share 310-1 (labeled 310-1A in FIG. 4C) may include bits 1-18 and sub-portion B of key share 310-1 (labeled 310-1B in FIG. 4C) may include bits 112-170. In FIG. 4C, key share 310-1 is programmed into two non-contiguous portions of reserved eFuse slot 106. Similarly, key share 310-2 includes two non-contiguous sub-portions A and B. Sub-portion A of key share 310-2 includes bits 19-111 (shown as empty) and sub-portion of key share 310-2 includes bits 171-256 (shown as empty). In the example of FIG. 4C, the bits of the two key shares are comingled with one another. In the example of FIG. 4C, key share 310-1, formed of sub-portions A and B, is programmed into portions of reserved eFuse slot 106 leaving other portions, shown as the shaded regions, unprogrammed or empty.

The examples of FIGS. 4A, 4B, and 4C are provided for purposes of illustration only. The split or delineation of bits between key share 310-1 and 310-2 may differ from the examples illustrated. Reserved eFuse slot 106 is implemented such that one or more portions may be programmed leaving other portions unprogrammed or empty so that such portions may be programmed at a later time. Further, in one or more examples, each location in reserved eFuse slot 106 may be bit-wise addressable such that any combination of bits of reserved eFuse slot 106 may be allocated or used for key share 310-1 with the remaining bits allocated for key share 310-2.

The examples illustrated in FIGS. 4A, 4B, and 4C illustrate another aspect of the split-key technique described herein. In one or more examples, the first entity may use the same hash for different customer and utilize a different split for the different customers. Because reserved eFuse slot 106 may be written on a bit-wise basis, the same level of security will still exist from one customer to another as each customer will only be in possession of their specific key share. The key share of one customer will not be the same as the key share of another which will use a different split of hash 308. Thus, each customer may program different portions of reserved eFuse slot 106.

As noted, the operations described up through block 216 may be performed as a matter of course upon obtaining, purchasing, or acquiring an IC device from the IC provider. As illustrated in FIG. 2, at some point the second entity may encounter an issue for which diagnostic services of the IC provider are required. As illustrated, the second entity may initiate an RMA for IC device 100.

In block 218, the second entity computer system is capable of creating a signed boot image for writing reserved eFuse slot 106. The boot image is signed using a private key that corresponds to or matches the private key programmed into eFuse slot 102 or 104, for example. The boot image generated in block 218 may be one having limited functionality that only enables or implements circuitry in IC device 100 allowing the recipient of the boot image to write to the empty or unprogrammed portions of reserved eFuse slot 106. As an example, the boot image created in block 218, upon loading and being authenticated in IC device 100 by A-HWRoT 108, may enable, or unlock, eFuse write circuitry 110. In another example, the boot image may implement eFuse write circuitry in programmable logic. In some examples, eFuse write circuitry 110 may include a Joint Test Action Group (JTAG) port of IC device 100 through which reserved eFuse slot 106 may be written in a bit addressable manner to write to the unprogrammed portions of reserved eFuse slot 106. The signed boot image may unlock any such circuitry, e.g., the JTAG port, to write to reserved eFuse slot 106.

In one or more examples, the signed boot image may contain or implement a “DNA” check. IC device 100, for example, may contain a read-only code implemented/programmed into IC device 100 at the time of manufacture or shortly thereafter. The DNA of IC device 100 is not re-writable. The read-only code is unique to IC device 100 and is referred to as the “DNA” of IC device 100. The IC provider and the customer may be privy to this information.

Accordingly, in one or more examples, the signed boot image created in block 218 may have embedded therein a code (e.g., the DNA) and implement a check function. Upon loading the signed boot image into the IC device, the check function, as executed by A-HWRoT 108 reads the DNA of the IC device and compares the DNA of the IC device with the code embedded in the signed boot image for a match. In response to detecting that the DNA of the IC device does not match the embedded code, A-HWRoT 108 is capable of discarding the signed boot image. In that case, the boot image is not used to configure or program the IC device. In response to detecting that the DNA does match the embedded code, A-HWRoT 108 allows the boot image to be used to program and/or configure the device (e.g., presuming the signature of the signed boot image corresponds to a value programmed into one of the eFuse slots). The DNA check is in addition to having a valid signature that makes the boot image useful only for a particular device—e.g., the IC device with matching DNA. This prevents the signed boot image from being used with other IC devices in the event the signed boot image is leaked to unauthorized parties.

In one or more other examples, the first entity may generate the boot image which may include the DNA check and then provide the boot image to the second entity. In that case, the second entity may sign the boot image with their private key corresponding a value stored in either eFuse slot 102 or eFuse slot 104.

In block 220, the second entity computer system is capable of providing the signed boot image to the first entity. Further, as illustrated in FIG. 2, the first entity provides IC device 100 to the second entity. The second entity may wipe or blank IC device 100 prior to sending to the first entity. Appreciably, the eFuses 102, 104, and 106 remain in their written, partially written, and/or revoked states as the case may be despite blanking of IC device 100.

In block 222, the first entity computer system loads the signed boot image received from the second entity into IC device 100. Upon loading, because the signed boot image from the second entity is signed with a private key matching a public key or hash of a public key programmed into eFuse slot 102 or eFuse slot 104, the A-HWRoT 108 allows IC device 100 to be programmed or configured by the signed boot image.

In block 224, with IC device 100 having been programmed or configured by the signed boot image from the second entity, the second entity computer system programs the second key share, e.g., key share 310-2, into the unprogrammed portions of reserved eFuse slot 106.

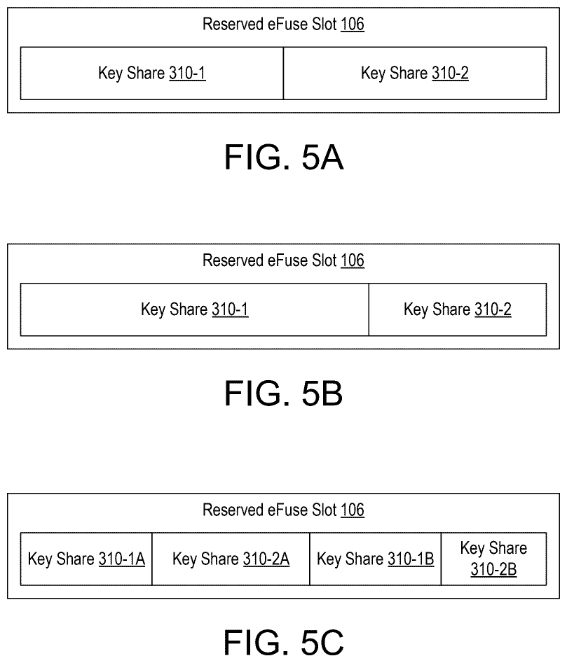

For purposes of illustration, FIGS. 5A, 5B, and 5C illustrate example states of reserved eFuse slot 106 with both key shares having been programmed. FIG. 5A corresponds to the example of FIG. 4A after the second entity computer system programs key share 310-2 into the unused portion of reserved eFuse slot 106. FIG. 5B corresponds to the example of FIG. 4B after the second entity computer system programs key share 310-2 into the unused portion of reserved eFuse slot 106. FIG. 5C corresponds to FIG. 4C after the second entity computer system programs sub-portions A and B of key share 310-2 (illustrated as key shares 310-2A and 310-2B) into the unused portions of reserved eFuse slot 106.

In block 226, the second entity is capable of performing diagnostics on IC device 100. For example, with reserved eFuse slot 106 now storing the entirety of hash 308, the second entity may load into IC device 100 one or more diagnostic boot images each signed with private key 306 of key pair 302. The example techniques described herein provide a secure mechanism for customers to obtain RMA support for IC devices.

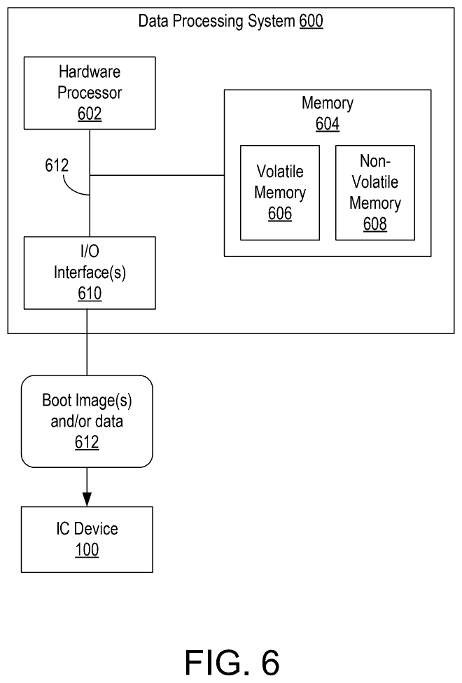

FIG. 6 illustrates an example of a data processing system 600. As used herein, “data processing system” refers to one or more hardware systems capable of processing data. Each hardware system may include one or more hardware processors and memory. Data processing system 600 is an example of a computer system used by the first and/or second entity that is capable of interacting with IC device 100 to perform the various operations described herein.

Data processing system 600 includes a hardware processor 602. Hardware processor 602 may be implemented as one or more hardware processors. Hardware processor 602 may be implemented as one or more circuits capable of executing computer-readable program instructions (program instructions). The circuit(s) may comprise integrated circuits (ICs) or may be embedded within an IC. In one or more examples, hardware processor 602 may be embodied as a central processing unit (CPU). Hardware processor 602 may include one or more cores, for example, where each core is capable of executing computer-readable program instructions. Hardware processor 602 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like.

Data processing system 600 can include memory 604. Memory 604 may be embodied as one or more computer-readable storage mediums. Memory 604 may include a volatile memory 606 and a non-volatile memory 608. Volatile memory 606 may be embodied as random-access memory (RAM) and may include cache memory. Volatile memory 606 may be referred to as “runtime memory.” Non-volatile memory 608 may include a non-volatile magnetic medium and/or a solid-state medium (typically called a “hard drive”). Non-volatile memory 608 also may include one or more disk drives capable of reading from and writing to various types of removable, non-volatile mediums such as a removable, non-volatile magnetic disk (e.g., a “floppy disk”) and/or a removable, non-volatile optical disk such as a CD-ROM, DVD-ROM or other optical media.

Memory 604 is capable of storing program instructions and/or data such that hardware processor 602 is capable of executing the program instructions to perform one or more operations as described within this disclosure. For example, the program instructions can include an operating system, one or more application programs, other program code, and program data. Hardware processor 602, in executing the computer-readable program instructions, is capable of performing the various operations described herein that are attributable to a computer. For example, hardware processor 602 is capable of performing operations such as generating a key pair, generating hashes of values such as public keys, splitting the hash, sharing data with another computer system, generating boot images, signing boot images, loading boot images and/or data into IC device 100, and/or programming reserved eFuse slot 106 within IC device 100 as described herein.

Data processing system 600 may include one or more Input/Output (I/O) interfaces 610. I/O interface(s) 610 allow data processing system 600 to communicate with one or more external devices and/or communicate over one or more networks such as a local area network (LAN), a wide area network (WAN), and/or a public network (e.g., the Internet). Examples of I/O interfaces 610 may include, but are not limited to, network cards, modems, network adapters (wired and/or wireless), hardware controllers, etc. Examples of external devices also may include devices that allow a user to interact with data processing system 600 (e.g., a display, a keyboard, and/or a pointing device) and/or other devices such as an accelerator card. In the example, data processing system 600 is coupled to IC device 100 and may load boot image(s) and/or other data into IC device 100.

Bus 612 represents one or more of any of a variety of communication bus structures. By way of example, and not limitation, bus 612 may be implemented as a Peripheral Component Interconnect Express (PCIe) bus. Bus 612 couples to each of hardware processor 602, memory 604, and I/O interface(s) 610 through respective interface circuitry thereby allowing the devices to communicate. Bus 612 may represent a plurality of buses that may be interconnected and/or hierarchically organized.

Data processing system 600 is only one example implementation. Data processing system 600 can be practiced as a standalone device (e.g., as a user computing device or a server, as a bare metal server), in a cluster (e.g., two or more interconnected computers), or in a distributed cloud computing environment (e.g., as a cloud computing node) where tasks are at least partially performed by remote processing devices that are linked through a communications network. In a distributed cloud computing environment, program modules may be located in both local and remote computer system storage media including memory storage devices.

The example of FIG. 6 is not intended to suggest any limitation as to the scope of use or functionality of example implementations described herein. Data processing system 600 is an example of computer hardware that is capable of performing the various operations described within this disclosure. In this regard, data processing system 600 may include fewer components than shown or additional components not illustrated in FIG. 6 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular examples only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, the terms “in response to” and “responsive to” mean responding or reacting readily to an action or event. Thus, if a second action is performed “in response to” or “responsive to” a first action, there is a causal relationship between an occurrence of the first action and an occurrence of the second action. The term “responsive to” indicates the causal relationship. In some cases, other terms such as “if,” “when,” or “upon” are used and also convey a causal relationship.

As defined herein, the term “user” refers to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc., may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the implementations described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the implementations described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the implementations described herein.

Certain aspects of the implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the implementations. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various implementations of the disclosed technology have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

What is claimed is:

1. A method, comprising:
generating, by computer hardware of a first entity, a hash of a public key of a key pair;
splitting, by the computer hardware of the first entity, the hash into a plurality of key shares;
sharing a first key share of the plurality of key shares with a second entity, wherein the first key share is programmed into a reserved electronic fuse (eFuse) slot of an integrated circuit device by the second entity;
loading into the integrated circuit device a boot image signed by the second entity, wherein the boot image is configured to unlock access to circuitry configured to write to the reserved eFuse; and
programming a second key share of the plurality of key shares into the reserved eFuse slot.

2. The method of claim 1, wherein the second key share is programmed into the reserved eFuse slot by computer hardware of the second entity.

3. The method of claim 1, wherein the second key share is programmed into the reserved eFuse slot by the computer hardware of the first entity.

4. The method of claim 1, wherein the first key share is programmed into a first portion of the reserved eFuse slot and the second key share is programmed into a second portion of the reserved eFuse slot.

5. The method of claim 1, wherein the boot image includes a code and is configured to unlock the access to the circuitry of the integrated circuit device in response to detecting a match between the code and a DNA of the integrated circuit device.

6. The method of claim 1, further comprising:
loading a further boot image into the integrated circuit device, wherein the further boot image is signed by the first entity and validated against the hash stored in the reserved eFuse slot.

7. The method of claim 1, wherein the first key share is formed of a first plurality of contiguous bits of the hash; and
wherein the second key share is formed of a second plurality of contiguous bits of the hash.

8. The method of claim 7, wherein the first plurality of contiguous bits of the hash are programmed into a first contiguous portion of the reserved eFuse slot; and
wherein the second plurality of contiguous bits of the hash are programmed into a second contiguous portion of the reserved eFuse slot.

9. The method of claim 1, wherein the first key share is formed of a first plurality of non-contiguous bits of the hash; and
wherein the second key share is formed of a second plurality of non-contiguous bits of the hash.

10. The method of claim 9, wherein the first plurality of non-contiguous bits of the hash are programmed into a first plurality of non-contiguous locations in the reserved eFuse slot; and
wherein the second plurality of non-contiguous bits of the hash are programmed into a second plurality of non-contiguous locations in the reserved eFuse slot.

11. The method of claim 10, wherein the first plurality of non-contiguous bits are comingled with the second plurality of non-contiguous bits as stored in the reserved eFuse slot.

12. An integrated circuit device, comprising:
an asymmetric-hardware Root of Trust (A-HWRoT);
a plurality of electronic fuse (eFuse) slots, wherein a selected eFuse slot of the plurality of eFuse slots is reserved for diagnostics;
wherein the selected eFuse slot is writable at a first time to store a first portion of a hash of a public key of a key pair and writable at a second time subsequent to the first time to store a second portion of the hash.

13. The integrated circuit of claim 12, wherein the first portion of the hash is programmed into a first portion of the reserved eFuse slot and the second portion of the hash is programmed into a second portion of the reserved eFuse slot.

14. The integrated circuit of claim 12, wherein the first portion of the hash is formed of a first plurality of contiguous bits of the hash; and
wherein the second portion of the hash is formed of a second plurality of contiguous bits of the hash.

15. The integrated circuit of claim 14, wherein the first plurality of contiguous bits of the hash are programmed into a first contiguous portion of the reserved eFuse slot; and
wherein the second plurality of contiguous bits of the hash are programmed into a second contiguous portion of the reserved eFuse slot.

16. The integrated circuit of claim 12, wherein the first portion of the hash is formed of a first plurality of non-contiguous bits of the hash; and
wherein the second portion of the hash is formed of a second plurality of non-contiguous bits of the hash.

17. The integrated circuit of claim 16, wherein the first plurality of non-contiguous bits of the hash are programmed into a first plurality of non-contiguous locations in the reserved eFuse slot; and
wherein the second plurality of non-contiguous bits of the hash are programmed into a second plurality of non-contiguous locations in the reserved eFuse slot.

18. The integrated circuit of claim 17, wherein the first plurality of non-contiguous bits are comingled with the second plurality of non-contiguous bits as stored in the reserved eFuse slot.

19. A system, comprising:
a hardware processor; and
one or more computer-readable storage mediums having program instructions stored thereon to cause the hardware processor to perform operations comprising:
generating, by computer hardware of a first entity, a hash of a public key of a key pair;
splitting, by the computer hardware of the first entity, the hash into a plurality of key shares;
sharing a first key share of the plurality of key shares with a second entity, wherein the first key share is programmed into a reserved electronic fuse (eFuse) slot of an integrated circuit device by the second entity;
loading into the integrated circuit device a boot image signed by the second entity, wherein the boot image is configured to unlock access to circuitry configured to write to the reserved eFuse; and
programming a second key share of the plurality of key shares into the reserved eFuse slot.

20. The system of claim 19, wherein the first key share is programmed into a first portion of the reserved eFuse slot and the second key share is programmed into a second portion of the reserved eFuse slot.
